(19) United States
(12) Patent Application Publication
(10) Pub. No.: US 2009/0187631 A1
(43) Pub. Date: Jul. 23, 2009

(54) AGGREGATED MESSAGE TRACKING STATUS NOTIFICATION MECHANISM

(75) Inventors: Sung-hsun Su, Redmond, WA (US); Yamin Wang, Bellevue, WA (US); Oleg Ouliankine, Redmond, WA (US); Gautam Pulla, Redmond, WA (US); Jeffrey Kay, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/017,337

(22) Filed: Jan. 22, 2008

(51) Int. Cl. G06F 15/16

(52) U.S. Cl. 709/206

(57) ABSTRACT

A notification mechanism that aggregates multiple email tracking status updates into a new type of aggregated message, and transports this new type of message according to a configured interval. The tracking status transported in this aggregated status message can be a positive delivery event, a negative delivery event, hand-off of ownership, or any information to be communicated. This information can be delivered to email users to provide information about the message delivery and, routed to messaging system applications such as journaling (to allow rich delivery information in a journal report) and/or high-availability transport (to allow resubmission of a message in case of hardware failure).

### BACKGROUND

Obtaining the historical record of the delivery of a message to the intended recipients is important to many organizations in a variety of scenarios. Individuals in certain roles that send a message may be interested in knowing whether a recipient did indeed receive the message. For example, legal discovery requires that a subpoenaed organization produce not only copies of the original message sent, but also evidence of the delivery of the message to the recipient. This set of information is typically spread across individual user mailboxes, journal reports, and message tracking logs. Organizations must archive all of this content, sometimes for years, and then dedicate resources to combing through the content in order to meet discovery requirements.

In the context of email, in order to confirm the delivery status of an email message a user has sent, the user typically needs to request a positive delivery status notification (DSN) (also referred to as a delivery receipt). Enabling DSNs causes mail flow in the messaging system to significantly increase, and may cause the sender to receive a large number of DSNs if the message has many recipients. Additionally, the information in a DSN cannot be used to communicate other types of information to systems such as whether the message is handed to another organization, for example. Moreover, email systems have no mechanism to provide delivery status for messaging functionality such as journaling or high availability transport.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The notification mechanism aggregates multiple email tracking status updates into a new type of delivery status message, and transports this message according to a configured interval (e.g., every minute). The tracking status being transported can be a positive delivery event, a negative delivery event, hand-off of ownership, or any information needed to be communicated. This information can be delivered to email users to provide information about the message delivery, routed to messaging system applications such as journaling (to allow rich delivery information in a journal report), and/or high-availability transport (to allow resubmission of a message in case of hardware failure).

More specifically, the mechanism aggregates multiple delivery status notifications into a single aggregated delivery status notification message. The mechanism reduces the load of the messaging system caused by regular delivery status notifications, communicates message status updates other than positive and negative delivery, provides the end user with accurate delivery status information (a message history), provides actual delivery status in a journal report, identifies missing messages due to hardware failure and to achieve high availability, and provides other messaging functionalities (e.g., read, replied to, forwarded) with accurate delivery status information.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented message status system.

FIG. 2 illustrates a more detailed diagram of message status notification system.

FIG. 3 illustrates a computer-implemented message status system for delivering aggregated status messages to a journaling server for journal reports.

FIG. 4 illustrates a computer-implemented message status system for delivering aggregated status messages to a high-availability transport system for resubmission of the original aggregated status message.

FIG. 5 illustrates a computer-implemented method of processing message notifications.

FIG. 6 illustrates an alternative method of processing message notifications.

FIG. 7 illustrates a method of providing a message history for an email.

FIG. 8 illustrates an optimization for handling aggregated status messages.

FIG. 9 illustrates a method of processing event information for aggregation.

FIG. 10 illustrates an alternative method of processing event information for aggregation.

FIG. 11 illustrates a block diagram of a computing system operable to execute aggregation and de-aggregation in accordance with the disclosed architecture.

FIG. 12 illustrates a schematic block diagram of an exemplary computing environment for message status aggregation and distribution.

### DETAILED DESCRIPTION

The disclosed architecture allows for obtaining message delivery status information for messages via the aggregation email tracking status updates into a new type of delivery status message. This information can be obtained arbitrarily long after the message has been sent and processed at the destination, and without any intervention by the message sender (or source) or message recipient. For example, the sender of an email no longer has to stipulate a delivery receipt to monitor if the recipient received the email. The architecture logs receipt of the email when the email is delivered to the recipient's mailbox, and can periodically send the delivery status information back to the sender. The delivery status information is delivered in a more efficient manner by aggregating multiple delivery status notifications as a single file and sending the aggregated file to a mail server for processing to the individual senders.

In the context of email messages, for example, if a sender distributed a single email to ten recipients requesting a delivery receipt from each recipient, the conventional email system has to process ten return messages. In accordance with the disclosed architecture, the recipient server will aggregate multiple notifications designated to a single sender server and send the aggregated file as a smaller number of messages (e.g., a single message) rather than ten separate messages thereby providing a significant improvement by reduced impact on email system processing and network bandwidth. Where the delivery notifications are for different sender servers, then aggregated files can be sent to the corresponding servers.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

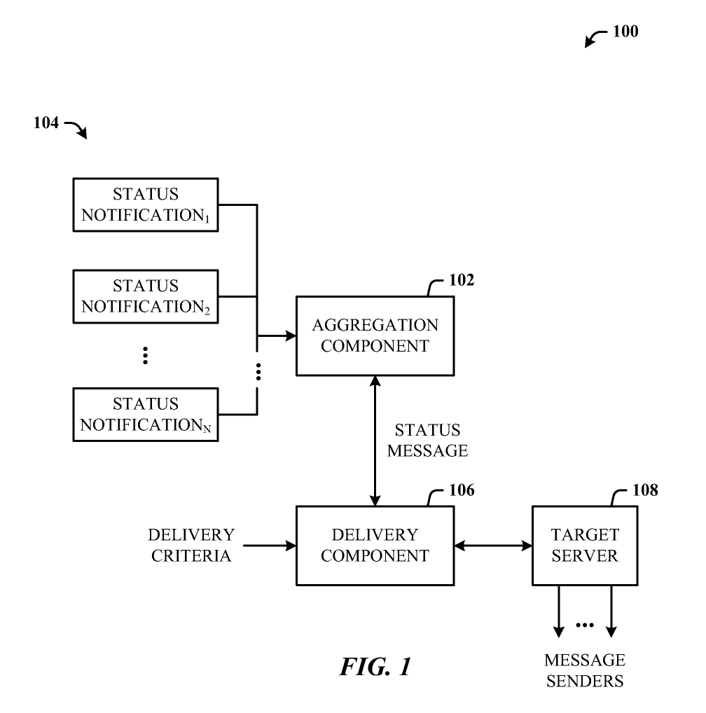

FIG. 1 illustrates a computer-implemented message status system 100. The system 100 includes an aggregation component 102 for aggregating message status notifications 104 associated with status updates of messages into a status message. A delivery component 106 delivers the status message to a target server 108 according to predetermined delivery criteria. The aggregation component 102 and the delivery component 106 can be part of a recipient message server system that receives and processes messages from senders, and the target server 108 can be the sender message server system that processes outgoing messages to the recipient message server system and messages sent to the sender of the original message (to be tracked). In other words, ultimately, delivery status information is returned from the recipient system(s) to the sender system(s).

The criteria processed by the delivery component 106 for sending the aggregated status message file to the target server 108 can be based on time and/or file size. For example, the time can be configured to send the aggregated message every two minutes. The aggregated status message is delivered to the target server 108, which then processes the aggregated status message notifications into separate pieces of delivery information to the senders. In other words, the target server 108 processes the status message into information for message (e.g., email) users related to delivery of the message (email) to intended recipients.

Consider the following example where there are two servers, a sending Server A and a recipient Server B, in the messaging system. Two users of the sending Server A, designated as sender user A and sender user B, are sending messages to recipient user C and recipient user D on recipient Server B. There are five messages sent between a time span of 2:37:00 pm to 2:37:59 pm: Message1 from sender user A to recipient user C, Message2 from sender user B to recipient user D, Message3 from sender user A to recipient user C and recipient user D, Message4 from sender user A to recipient user D, and Message5 from sender user B to recipient user C.

Without the aggregated message tracking status notification mechanism, a delivery receipt can be specified by the senders, but then requiring six delivery receipt messages from recipient server B back to sender server A, thereby substantially increasing the load of the messaging system. The system can combine two delivery status messages for the third message, thereby reducing the number to five.

When using the aggregated message tracking status notification mechanism, instead of generating the notification messages immediately, the following five entries are stored on the recipient server B.

| Target | Event Details |
|---|---|
| Server A | Message1, delivered to user C |
| Server A | Message2, delivered to user D |
| Server A | Message3, delivered to user C/user D |
| Server A | Message4, delivered to user D |
| Server A | Message5, delivered to user C |

At 2:38:00 pm, recipient Server B checks the list and finds the five entries. Since the entries are all destined for sender Server A, the entries are packed into a single status message, and the single message is delivered to sender Server A. Sender Server A receives the single status message, unpacks and reads all five entries, and updates the information for the Server A sender users A and B. Thus, only a single status message is employed providing a significant reduction in the impact on server processing and network bandwidth. On a high performance message (e.g., email) server that processes many more messages, the performance improvement with this mechanism is even more significant.

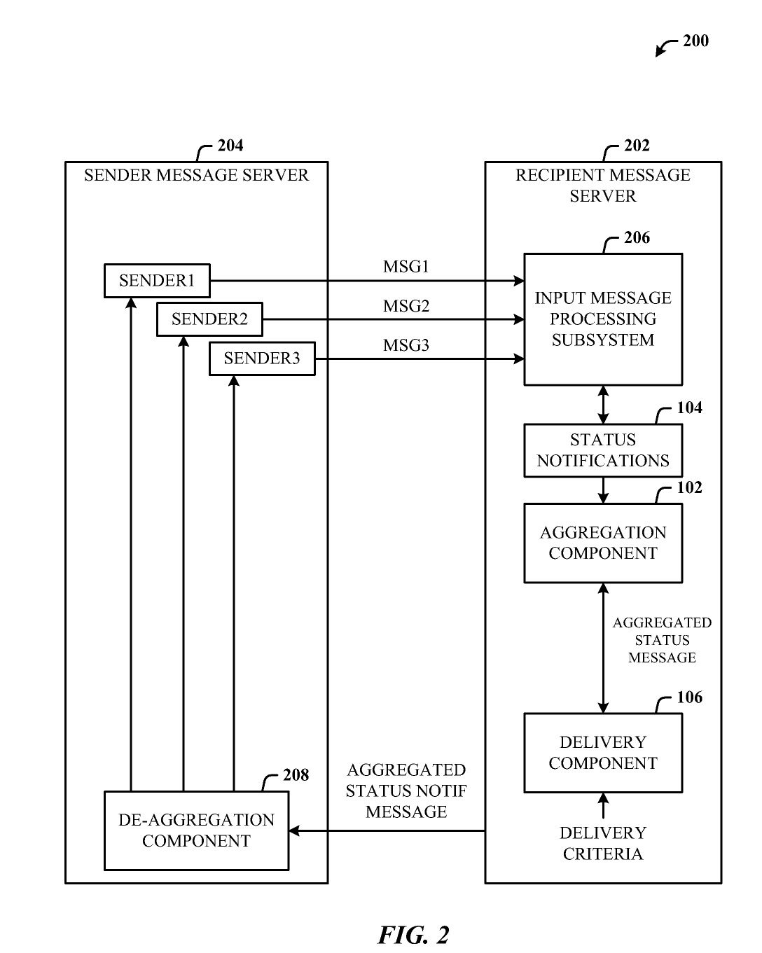

FIG. 2 illustrates a more detailed diagram of message status notification system 200. Here, the system 200 shows a recipient message server 202 for receiving messages from senders of a sender message server 204. The messages are received at the recipient server 202 and into an input message processing subsystem 206 that processes the incoming messages and outputs the status notifications 104. Events related to the message processing can include delivered, rejected, relayed, expanded, and delayed, for example.

In other words, the disclosed architecture communicates information other than the positive and negative delivery status information. The delivered event is a positive delivery status notification which means the message is delivered to the specific recipient. The rejected event is a negative delivery status notification which means the message is rejected and the specific recipient did not get the message. The relayed event means that the message for the specific recipient has been accepted by another organization. The expanded event means that the specific recipient is a distribution list and has been expanded to other recipients. The delayed event means that the message for the specific recipient is delayed.

Other events that can be employed include, but are not limited to, tracking when the message is deleted, forwarded, saved to storage, replied to, group/DL (distribution list) expansion, and the actual opening of the message (a read receipt) by the intended recipient, rather than tracking only placement of the message into the recipient message container.

The input message processing system 206 sends status notifications 104, which include one or more of these events, to the aggregation component 102 for insertion into the distribution list. In this particular example, all list entries will be designated for the sender message server 204; however, this is not a requirement, in that the list can include entries for other servers as well. The aggregation component 102 groups the list entries according to the target server (e.g., sender message server 204), aggregates the grouped entries by target server into aggregated status messages, and passes the aggregated status messages to the delivery component 106 for communications to the appropriate sender message servers (e.g., server 204). The aggregated status message is received by a de-aggregation component 208 of the sender message server 204 that parses the individual notification entries from the status message file and transmits the entries separately to the individual senders.

It is to be appreciated that there may be multiple parsed notification entries for the same sender. At this time, the multiple notification entries for a single sender can be sent separately to the sender or as a group of entries to the sender. For example, the multiple notification entries for a single sender can be sent as a message (e.g., email) that lists the multiple notifications in a single message document. Thus, the sender can receive a message that provides a list of all notifications for messages sent in the last hour, day, week, etc.

The delivery criteria can also be user-based, rather than time-based, or in combination with time-based, or other rules. For example, the sender can configure the system such that when a message related to a specific recipient user (e.g., supervisor, department head, company head) is sent, the status notifications will be processed immediately or within a predetermined period of time (e.g., within one hour), thereby overriding another setting (e.g., default, sender-configured, etc.). The recipient message server 202 will then operate to process all status notifications at that time for delivery to the target server(s) as the aggregated message(s).

The delivery criteria can also be event-based such that, for example, when one or more messages are delay, relayed, expanded, delivered, or rejected, the recipient message server 202 will then operate to process all status notifications at that time for delivery to the target server(s) as the aggregated message(s). Many different types of rules can be employed for imposing delivery criteria. For example, if the aggregate status message reaches a certain size, this may be the criteria which cause sending of the aggregated message to the desired systems/users.

In yet another example, the delivery criteria can be related to message size or type. For example, if the sender imposes a file size limitation, the recipient message server 202 can be configured to automatically process status notifications for delivery and processing when the file size meets the imposed criteria. If the message is related to a type of content (e.g., audio, video, etc.), the recipient message server 202 can be configured to automatically process status notifications into the aggregated files for delivery and processing.

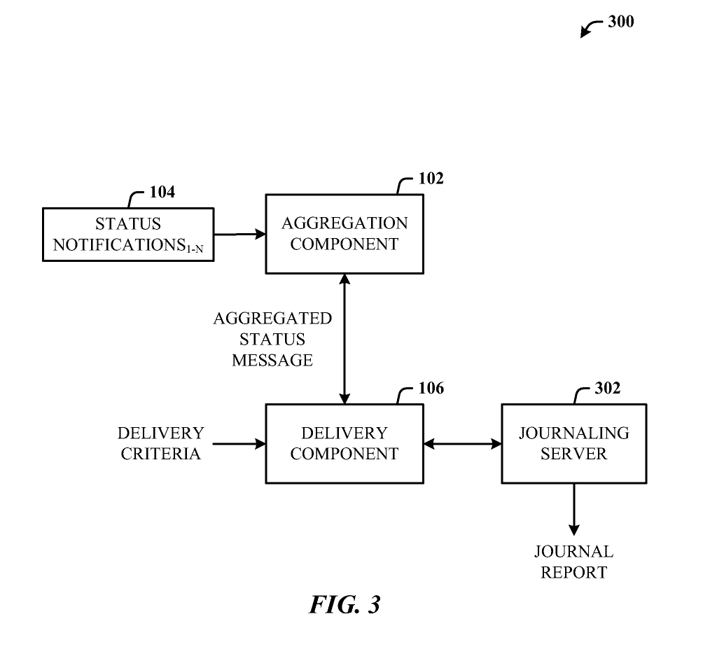

FIG. 3 illustrates a computer-implemented message status system 300 for delivering aggregated status messages to a journaling server 302 for journal reports. Envelope journaling that is currently available provides a list of all intended recipients. However, journaling does not record information about whether the message to the recipient is later rejected. This provides a challenge to the legal discovery process, for example, as it only proves that the sender sent the message but does not prove that the recipient actually got the message. A current practice is to journal non-delivery reports and then send these reports to the journaling archive. During a legal discovery process, those non-delivery reports need to be searched and associated back to the original journal report message (which contains envelope recipients and original message body). However, this current approach spreads the information in multiple messages and is costly.

Utilizing the aggregated status notification mechanism, the delivery information can be transmitted to the journaling server 302, allowing the server 302 to stamp the actual delivery status time and date information to the message and record this information. Because of the aggregation of status notifications, the cost or message volume increase to the overall messaging system is minimal.

Messaging history can be stored on a per-user basis. In addition to having message history about individual recipients, summarization can be provided for summarizing a total count of deliveries and failures for each distribution list recipient.

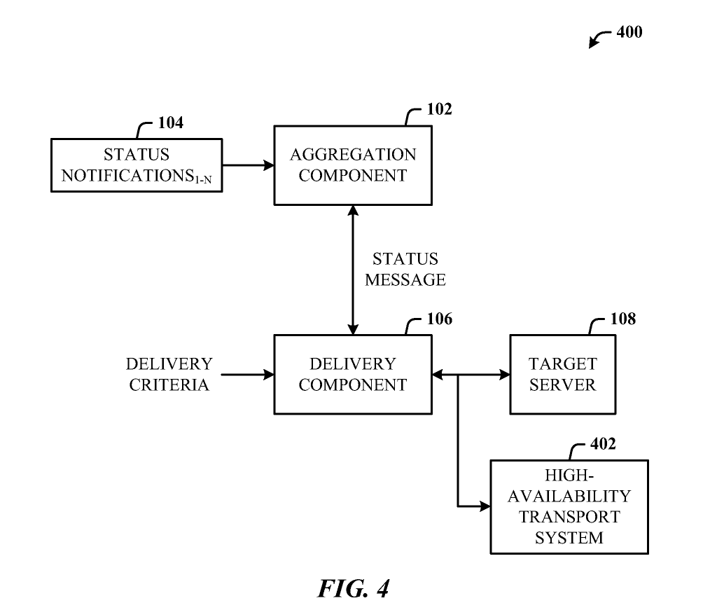

FIG. 4 illustrates a computer-implemented message status system 400 for delivering aggregated status messages to a high-availability transport system 402 for resubmission of the original aggregated status messages. The high-availability system 402 can operate in combination with the target server 108 as a backup for retransmission of one or more aggregated status message if the target server fails.

In a messaging server deployment where lower-cost machines are used, hardware failure rates can be significantly higher. Moreover, oftentimes, there is no hard disk redundancy to help mitigate the message loss due to hardware failure. Using aggregated status notification mechanism, the messaging system can hold a copy of the message for redundancy and wait for a positive delivery status notification before deleting the redundant copy. In case of a hardware failure that causes some messages to be lost, this delivery status information can be used to determine whether the redundant copy of message should be resubmitted. Because of the aggregation of status notification, the cost or message volume increase to the overall messaging system is minimal.

In a brief, but non-exhaustive summary, the disclosed mechanism will aggregate multiple message (e.g., email) tracking status updates into a new type of message, and transport this message according to a delivery criteria (e.g., time periods, event, users, etc.). The tracking status being transported in the aggregated status message can be positive delivery event, negative delivery event, hand-off of ownership, or any information needed to be communicated.

Hand-off of ownership means that there is a potential for a system to take ownership. For example, email can be involved with a custodial transfer system. When mail is delivered from Server A to Server B, Server B takes ownership (or custody) of that message, and Server A is relieved of any responsibility for delivering that message. It is possible that Server B, in taking ownership of that message, will not know how to send back further updates about delivery of that message. The disclosed mechanism can track the extent to which the message was handed-off and report this delivery information in the aggregated status message.

This information can be delivered to email users to provide the users information about the message delivery, or can be routed to messaging system applications such as journaling (to allow rich delivery information in a journal report) or high-availability transport (to allow resubmission of a message in case of hardware failure). The sender can receive this delivery information without actually requesting it by delivery receipts, reviewing logs, etc. Moreover, the delivery information can be received long after the message has been sent.

It is to be appreciated that the aggregated status message can be used not only to send information back to the sender, but also the asynchronous communication of delivery information between systems. For example, in hop-by-hop text messaging for custodial transfer, aggregated status messaging can be used to ensure message flow and/or for a quality-of-service (QoS) applications. In another example, message delivery status notifications can be aggregated where inter-system communications may be periodic such as with communications blackouts (e.g., interplanetary device communications). In still another example, disruption tolerant networking can utilize aggregated status messaging to ensure that information can be obtained under all conditions and for all purposes.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

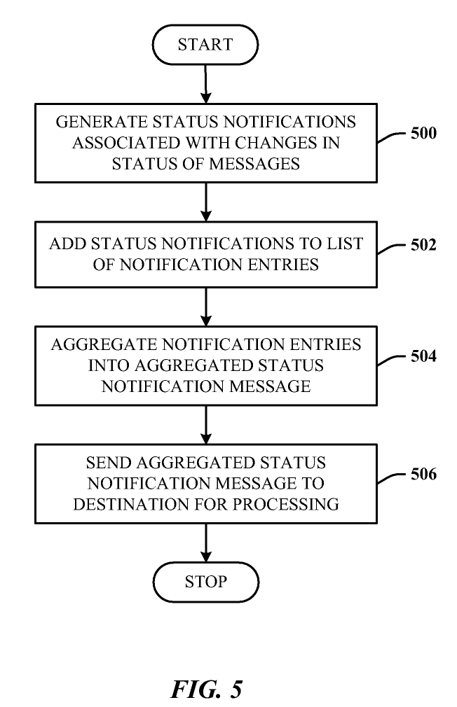

FIG. 5 illustrates a computer-implemented method of processing message notifications. At 500, status notifications associated with changes in status of messages are generated. At 502, the status notifications are added to a list of notification entries. At 504, notification entries are aggregated into an aggregated status notification message. At 506, the aggregated status notification message is sent to the destination (e.g., a sender server system) for processing.

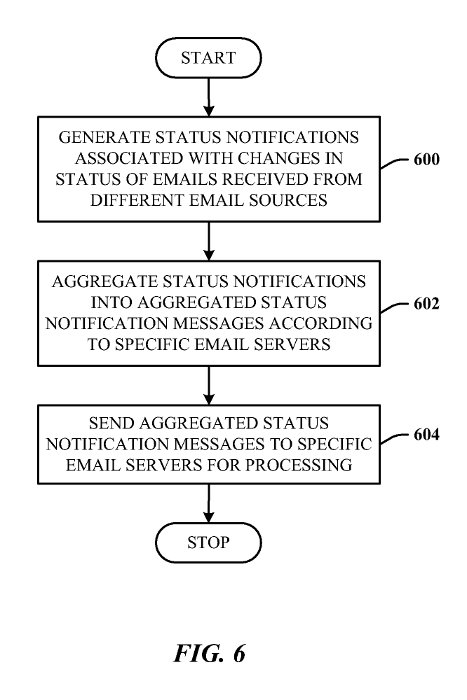

FIG. 6 illustrates an alternative method of processing message notifications. At 600, status notifications associated with changes in status of emails received from email sources are generated. At 602, the status notifications are aggregated into aggregated status notification messages according to specific email servers. At 604, the aggregated status notification messages are sent to the specific email servers for processing.

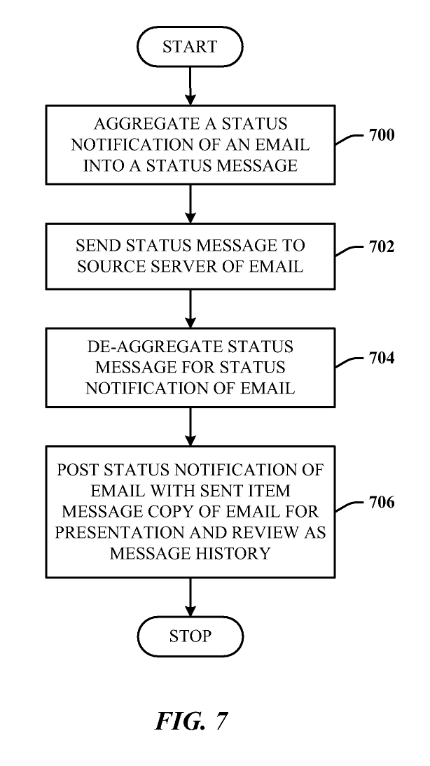

FIG. 7 illustrates a method of providing a message history for an email. At 700, a status notification of an email is aggregated into a status message. At 702, the aggregated status message is sent to the source server of the email. At 704, the status message is de-aggregated for the status notification of the email. At 706, the status notification of the email is posted with the sent item copy of the email for presentation and review as the message history.

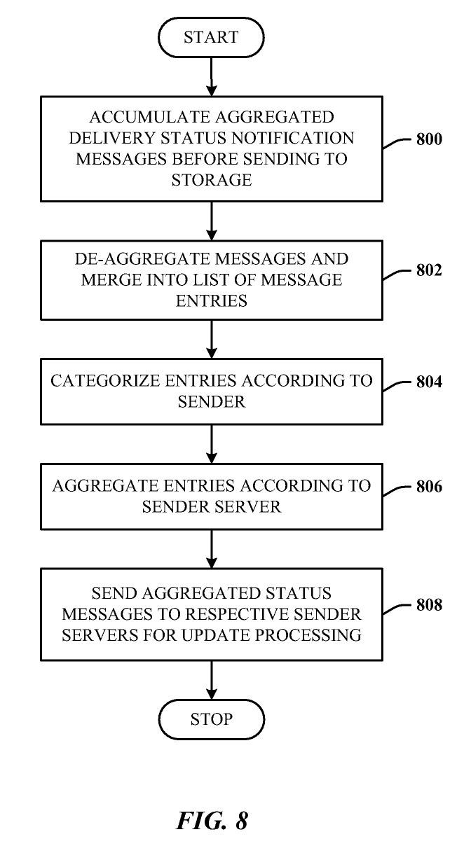

FIG. 8 illustrates an optimization for handling aggregated status messages. The optimization includes accumulating and processing aggregated status messages before sending to the sender server system in order to reduce the number of communications over the network to the sender servers. At 800, aggregated delivery status notification messages are accumulated at a target server. At 802, the aggregated messages are de-aggregated at the target server and merged into a list of message entries. At 804, the entries are categorized according to sender. At 806, the entries are aggregated according to the sender server. At 808, the aggregated status messages are sent to respective sender server systems for update processing.

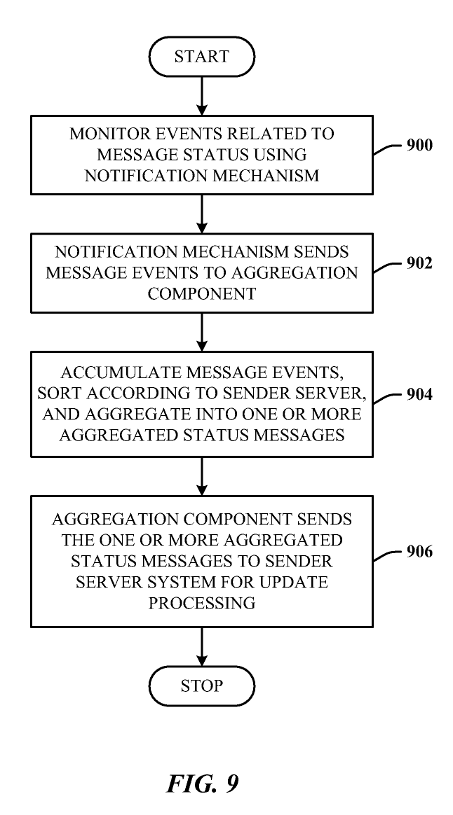

FIG. 9 illustrates a method of processing event information for aggregation. At 900, events related to message status are monitored using a notification mechanism. The events can include information related to if the message was delivered, rejected, relayed, expanded or delayed, for example. At 902, the notification mechanism sends the message events (either separately or in groups) to the aggregation component. Note that the notification mechanism and aggregation component can be software components of on the target server. At 904, the message events are accumulated and sorted at the aggregation component according to sender server, and aggregated into one or more status messages. At 906, the aggregation component sends the aggregated message to the corresponding sender server system for up[date processing.

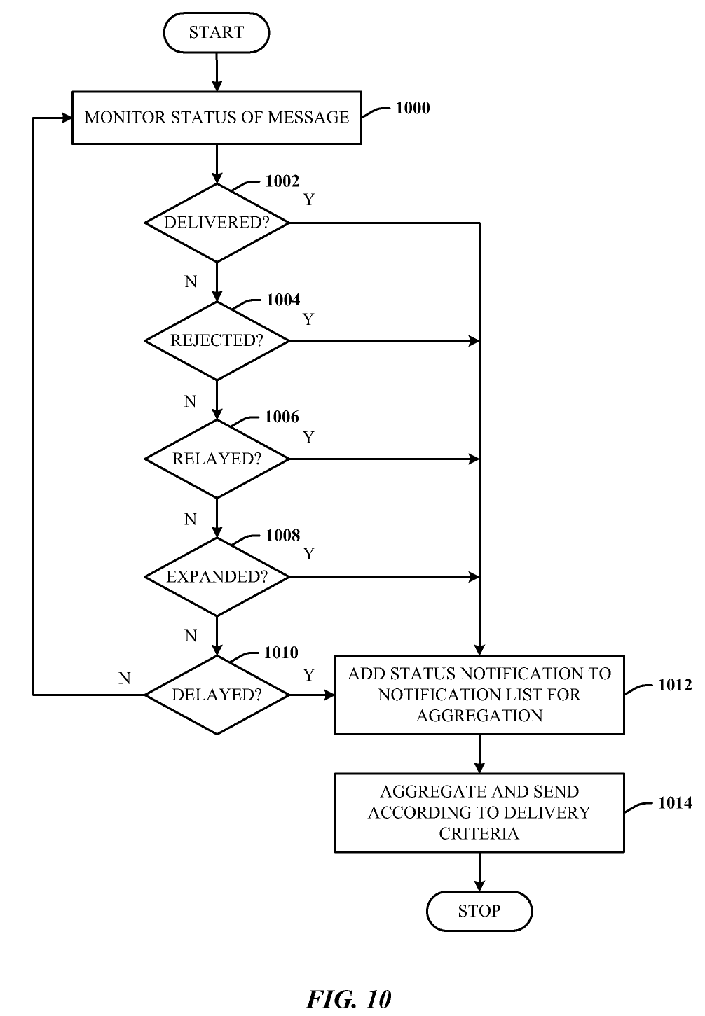

FIG. 10 illustrates an alternative method of processing event information for aggregation. At 1000, the status of a message (e.g., email) is monitored. At 1002, a check is made if the message was delivered. If not, flow is to 1004 to check if the message was rejected. If not, flow is to 1006 to check if the message was relayed. If not, flow is to 1008 to check if the message was expanded. If not, flow is to 1010 to check if the message was delayed. If none of the above, flow can be back to 1000 to continue monitoring for the message status. If any of the above checks are yes, flow is to 1012 to add the status notification to a notification list for aggregation. At 1014, the list is then aggregated and sent according to the delivery criteria.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

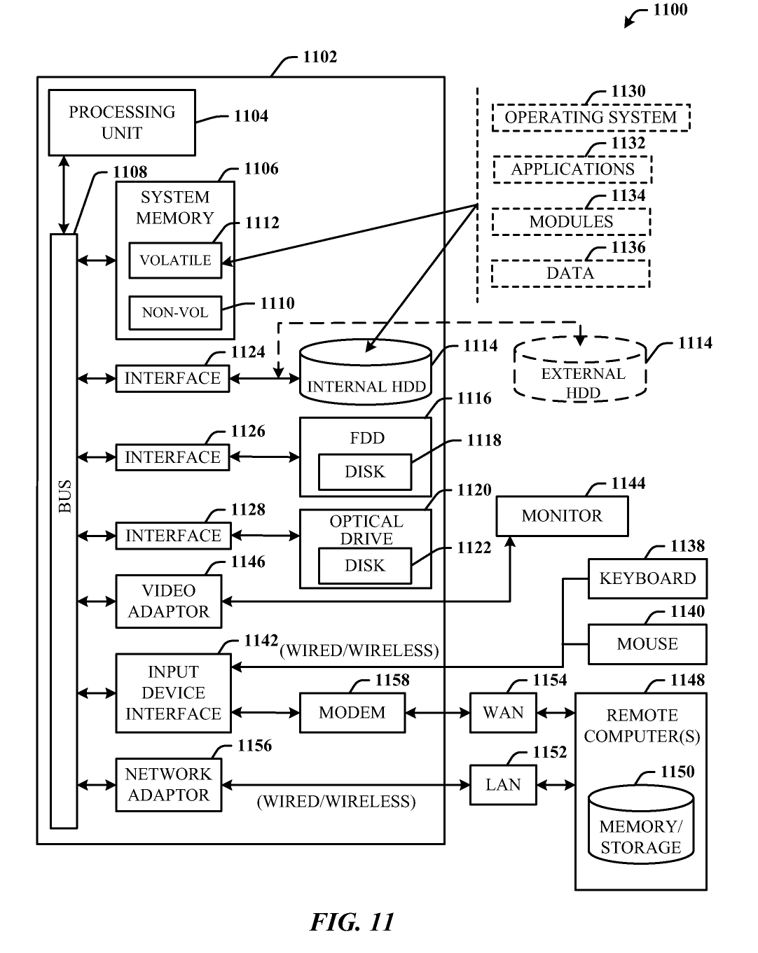

Referring now to FIG. 11, there is illustrated a block diagram of a computing system 1100 operable to execute aggregation and de-aggregation in accordance with the disclosed architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS are the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. In terms of the computing system 1100 being used as a server, the one or more application programs 1132, other program modules 1134, and program data 1136 can include the aggregation component 102, status notifications 104, delivery component 106, target system 108, delivery criteria, aggregated status message, recipient message server 202, sender message server 204, input message processing subsystem 206, de-aggregation component 208, the journaling server 302, and the high-availability transport system 402.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

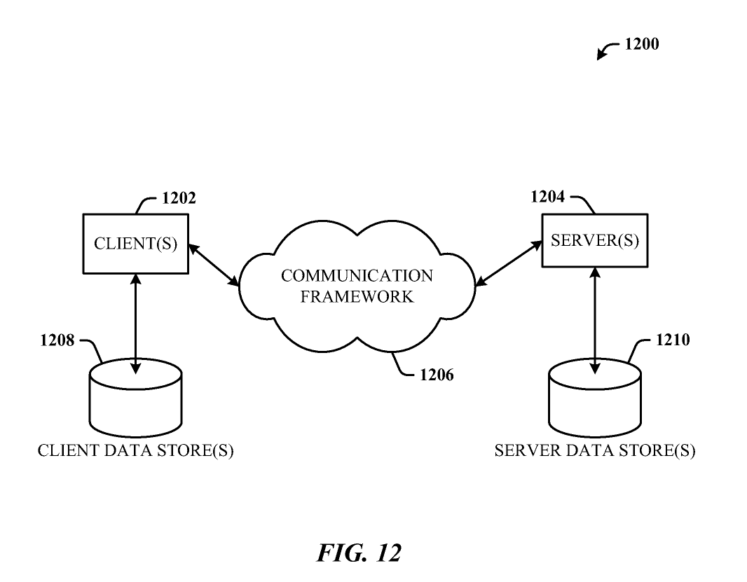

Referring now to FIG. 12, there is illustrated a schematic block diagram of an exemplary computing environment 1200 for message status aggregation and distribution. The environment 1200 includes one or more client(s) 1202. The client(s) 1202 can be hardware and/or software (e.g., threads, processes, computing devices). The client(s) 1202 can house cookie(s) and/or associated contextual information, for example.

The environment 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The environment 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The clients(s) 1202 can include client programs such as an email program, a text messaging program, or any media communications program for sending data to another user or system. The server(s) 1204 can include the target system 108, recipient message server 202, sender message server 204, the journaling server 302, and the high-availability transport system 402.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented message status system, comprising:
an aggregation component for aggregating message status notifications associated with status updates of messages into a status message; and
a delivery component for delivering the status message according to a predetermined delivery criteria.

2. The system of claim 1, wherein the criteria is a time interval based on which the status message is delivered for processing by a target server.

3. The system of claim 1, wherein the status message is delivered to a target server that processes the status message into information for email users related to delivery of email to intended recipients.

4. The system of claim 1, wherein the status message is delivered to a server that provides delivery information in a journal report.

5. The system of claim 1, wherein the status message is delivered to a high-availability transport for resubmission of the status message.

6. The system of claim 1, wherein the status message includes hand-off of ownership information.

7. The system of claim 1, wherein the status message includes information related to a relayed event, group/distribution list expansion event, or delayed event.

8. A computer-implemented method of processing message notifications, comprising:
generating status notifications associated with changes in status of messages;
adding the status notifications to a list of notification entries;
aggregating the notification entries into an aggregated status notification message; and
sending the aggregated status notification message to the destination for processing.

9. The method of claim 8, further comprising grouping the entries according to a specific destination.

10. The method of claim 8, wherein the destination is a message server that processes the aggregated status notification message to distribute the status notifications to respective message sources.

11. The method of claim 8, wherein the destination is a message server that processes the aggregated status notification message to return status notifications as a single message to a specific message source.

12. The method of claim 8, wherein the destination is a journaling server that stamps delivery status information to the aggregated status notification message and generates a journaling report of stamped status information.

13. The method of claim 8, further comprising retaining a copy of the status notification message at a high-availability transport and managing the copy based on delivery status information.

14. A computer-implemented method of processing message notifications, comprising:
generating status notifications associated with changes in status of emails received from email sources;
aggregating the status notifications into aggregated status notification messages according to specific email servers; and
sending the aggregated status notification messages to the specific email servers for processing.

15. The method of claim 14, further comprising storing the aggregated status notification messages as backups for retransmission to manage email system failures.

16. The method of claim 14, further comprising sending the aggregated status notification messages based on delivery criteria associated with time or an event.

17. The method of claim 14, further comprising recording delivery information to a sender in a journal.

18. The method of claim 14, further comprising aggregating a status notification related to hand-off of the emails to another email system.

19. The method of claim 14, further comprising aggregating status notifications related to the emails being relayed and delayed.

20. The method of claim 14, further comprising presenting a message history of an email to a user of an email source.
